(19) United States
(12) Patent Application Publication
(10) Pub. No.: US 2020/0039182 A1
(43) Pub. Date: Feb. 6, 2020

(54) LAMINATED BODY AND PRODUCTION METHOD THEREFOR

(71) Applicant: AGC Inc., Chiyoda-ku (JP)

(72) Inventors: Jin UEMURA, Shizuoka (JP); Kosuke AOKI, Shizuoka (JP); Koji MIYASAKA, Tokyo (JP)

(73) Assignee: AGC Inc., Chiyoda-ku (JP)

(21) Appl. No.: 16/601,779

(22) Filed: Oct. 15, 2019

Related U.S. Application Data
(63) Continuation of application No. PCT/JP2018/015920, filed on Apr. 17, 2018.

(30) Foreign Application Priority Data
Apr. 21, 2017 (JP) 2017 -084724

(51) Int. Cl. B32B 7/12; B32B 27/34

(52) U.S. Cl. CPC B32B 7/12; B32B 17/10761; B32B 27/34

(57) ABSTRACT

The present invention relates to a laminate in which a plurality of members including at least a glass are bonded via a bonding agent. The glass bonded has a chamfered portion in an end portion of a lamination surface of the glass, and the bonding agent adheres to the chamfered portion.

### TECHNICAL FIELD

The present invention relates to a laminate in which a plurality of members including a glass are bonded via a bonding agent, and a method for manufacturing the laminate.

### BACKGROUND ART

Patent Literatures 1 and 2 disclose laminates in which members including a glass are bonded via a bonding agent. Patent Literature 1 proposes a glass laminate for use in a display or the like. A bonding agent is put between a plurality of glass films provided with reflection films so as to integrate the glass films. Thus, a glass laminate is formed. In Patent Literature 1, how to apply the bonding agent is devised to attain prevention of bubbles in a layer of the bonding agent or reduction of a thickness variation in the layer of the bonding agent. Patent Literature 2 proposes a glass laminate excellent in infrared absorption function. The excellent infrared absorption function is attained by use of a near-infrared absorption glass in the glass laminate or by use of a bonding agent having an infrared absorption function.

### CITATION LIST

### Patent Literature

Patent Literature 1: JP-A-2015-187065
Patent Literature 2: JP-A-2017-14042

### SUMMARY OF INVENTION

### Technical Problem

However, when members including a glass are bonded via a bonding agent, the bonding agent may protrude from end portions of the members when laminating the members (see FIG. 15). When the bonding agent protrudes thus, characteristics or physical properties of the glass may be changed by the protruding bonding agent in use to affect a use application. A step of removing the protruding bonding agent may be provided, but the step affects following steps or causes a problem on manufacturing cost. In order to prevent the bonding agent from protruding, a method for reducing the amount of the bonding agent or applying the bonding agent to positions distant from the end portions may be used. In that case, however, the bonding agent cannot be sufficiently spread to the end portions, so that the members may be, for example, peeled off easily from the end portions. Thus, the adhesive force may be lowered. In order to improve the adhesive force or to prevent the members from being separated easily, it is preferable that the bonding agent is spread to the end portions.

An object of the present invention is to provide a laminate which prevents a bonding agent from protruding to adhere to a side surface of a glass and from affecting a use application, and a method for manufacturing the laminate.

### Solution to Problem

As a result of intensive studies made by the present inventor, it has been found that the aforementioned problem can be solved if a laminate in which at least one of laminated members is a glass is a laminate in which at least a lamination surface of the glass has a chamfered portion in an end portion thereof.

A laminate according to the present invention is characterized in that it is a laminate in which a plurality of members including at least a glass are bonded via a bonding agent, wherein the glass bonded has a chamfered portion in an end portion of a lamination surface of the glass, and the bonding agent adheres to the chamfered portion.

The laminate according to the present invention is characterized in that the bonding agent includes at least one kind selected from the group consisting of a UV-curing resin, an acrylic-based bonding agent, a silicone-based bonding agent, an urethane-based bonding agent, a polyamide-based bonding agent, a vinyl acetate-based bonding agent, an ester-based bonding agent, a styrene-based bonding agent, a cyanoacrylate-based bonding agent, a PVA-based bonding agent, a PP-based bonding agent, a PC-based bonding agent, a PET-based bonding agent, a PMMA-based bonding agent, a PES-based bonding agent, a PEN-based bonding agent, a cellulose-based bonding agent, a silane coupling-based bonding agent, and an epoxy-based bonding agent.

The laminate according to the present invention is characterized in that surface roughness of a bond portion of the lamination surface is lower than surface roughness of the chamfered portion.

A method for manufacturing a laminate according to the present invention is a method for manufacturing a laminate in which a plurality of members including at least a glass are bonded via a bonding agent, the method including chamfering an end portion of a lamination surface of the glass to form a chamfered portion; applying the bonding agent to a bond portion of at least one lamination surface of a plurality of the members; and bonding a plurality of the members via the bonding agent so that the bonding agent adheres to the chamfered portion.

### Advantageous Effects of Invention

According to the present invention, it is possible to provide a laminate which can prevent a bonding agent from protruding to adhere to side surfaces of a glass and members and from affecting characteristics of the members and a use application.

### BRIEF DESCRIPTION OF DRAWINGS

FIG. 1 shows an example of a side view of Embodiment 1 of a laminate according to the present invention.

FIG. 2 shows an example of a side view of Embodiment 2 of the laminate according to the present invention.

FIG. 3 shows an example of a side view of Embodiment 3 of the laminate according to the present invention.

FIG. 4 shows an example of a side view of Embodiment 4 of the laminate according to the present invention.

FIG. 5 shows an example of a side view of Embodiment 5 of the laminate according to the present invention.

FIG. 6 shows an example of a side view of Embodiment 6 of the laminate according to the present invention.

FIG. 7 shows an example of a side view of Embodiment 7 of the laminate according to the present invention.

FIG. 8 shows an example of a side view of Embodiment 8 of the laminate according to the present invention.

FIG. 9 shows an example of a side view of Embodiment 9 of the laminate according to the present invention.

FIG. 10 shows an example of a side view of Embodiment 10 of the laminate according to the present invention.

FIG. 11 shows an example of a lamination surface of the laminate according to the present invention.

FIG. 12 shows an example of the lamination surface of the laminate according to the present invention.

FIG. 13 shows an example of the lamination surface of the laminate according to the present invention.

FIG. 14 shows an example of the lamination surface of the laminate according to the present invention.

FIG. 15 shows an example of a laminate in the background art.

### DESCRIPTION OF EMBODIMENTS

In a laminate according to the present invention, a plurality of members including a glass as an essential member are bonded and laminated via a bonding agent, and a chamfered portion is provided at least in an end portion of a lamination surface of the glass.

In each drawing, a hatched portion designates the bonding agent, a dotted portion designates the chamfered portion, and a broken line portion designates an endmost portion of the lamination surface. In the present description, the lamination surface designates a surface where the glass or each member is bonded. In addition, the phrase “the bonding agent protrudes” means that the bonding agent adheres to the outside from the endmost portion of the lamination surface (the outside from the broken line portion, or a side wall surface of each member or the glass).

The laminate according to the present invention is constituted by two or more members, and at least one of the members is a glass. The composition of the glass is not limited particularly, but a borosilicate glass, an aluminosilicate glass, an alkali-free glass, a fluorophosphate glass, a phosphate glass, a silica glass, etc. may be used. In addition, the thickness, size and shape of the glass are not limited particularly. A glass subjected to processing suitable for an application, such as a glass with a functional film (such as an antireflection film, a reflection film, an infrared cutting/transmitting film, an ultraviolet cutting/transmitting film, an antifouling/dustproof film, etc.), a glass colored externally, a glass subjected to micro-processing, etc. may be used as the glass. When a plurality of glasses are used, the glasses may belong to the same kind of glass or different kinds of glasses.

Besides the glass, resin, metal, ceramic, sapphire, film, fiber materials, crystal, etc. may be used as the members constituting the laminate according to the present invention. Examples of applications of the members include an optical device, a prism, a biofilm, a culture substrate, a heat insulator, an electric circuit, etc.

In the laminate according to the present invention, the glass and another member (which may be a glass) are bonded via a bonding agent. The bonding agent is not limited particularly as long as it can bond the glass and the member firmly enough to prevent them from being separated from each other. As the bonding agent, one kind or two or more kinds selected suitably from a UV-curing resin, an acrylic-based bonding agent, a silicone-based bonding agent, an urethane-based bonding agent, a polyamide-based bonding agent, a vinyl acetate-based bonding agent, an ester-based bonding agent, a styrene-based bonding agent, a cyanoacrylate-based bonding agent, a PVA-based bonding agent, a PP-based bonding agent, a PC-based bonding agent, a PET-based bonding agent, a PMMA-based bonding agent, a PES-based bonding agent, a PEN-based bonding agent, a cellulose-based bonding agent, a silane coupling-based bonding agent, an epoxy-based bonding agent, etc, can be used.

The state of the bonding agent can be selected suitably from a liquid state, a gel state, a solid state, a tape state, a sheet state, etc. In order to enhance the adhesive force between the members, the liquid state or the gel state is preferred.

Of the members constituting the laminate according to the present invention, at least the glass has a lamination surface which includes a chamfered end portion (hereinafter referred to as a chamfered portion) and a portion to be applied with the bonding agent (hereinafter referred to as a bond portion). Due to the chamfered portion provided thus, the bonding agent adheres to the chamfered portion when the member is bonded via the bonding agent. Further, in the case where the bonding agent is spread, the bonding agent can be prevented from protruding to the outside from the end portion of the member. The position of the chamfered portion may be all over the circumference of the end portion of the lamination surface or partially in the circumference of the same. It is preferable that the end portion outside the position to which the bonding agent should be applied is formed as the chamfered portion.

The shape of the chamfered portion is not limited particularly, but it may be selected suitably from an R-chamfering, a C-chamfering, a slope, etc. When the shape is selected, it is preferable to select a shape with which the chamfered portion is prevented from affecting a use application. In addition, as for the area which is chamfered (hereinafter referred to as a chamfering area), length of the chamfering (hereinafter referred to as chamfering length) can be adjusted suitably both in the plane direction and in the thickness direction in accordance with the use application, the kind of the bonding agent, etc. When the bonding agent has a low viscosity (to flow easily) or when plenty of the bonding agent has to be applied, the chamfering length is increased in the plane direction and in the thickness direction. As a result, the volume of the chamfering area can be increased so that the protrusion of the bonding agent can be suppressed easily even if the bonding agent is much to be spread. The chamfering length in the thickness direction may be equal to the thickness. When the chamfering length in the thickness direction is made equal to the thickness, some slope angle or some chamfering formation position may reduce the bond portion or make the angle acute. Thus, it is likely to lead to a disadvantageous state in which the bonding agent, for example, tends to flow down. It is therefore preferable to adjust the chamfering length or angle suitably.

For example, in a structure in which other members are laminated above and below the glass, that is, a structure having three or more layers, the glass has lamination surfaces at its top and bottom surfaces. Therefore, chamfered portions are formed in end portions of the two lamination surfaces. The shape of the chamfered portion and the place where the chamfered portion is formed may be the same in both the top and bottom surfaces or may be different. It is preferable that the shapes and the places is adjusted suitably in accordance with the number of laminated layers or the combination of the members.

Each of the other members other than the glass may also have a chamfered portion. In the same manner as in the aforementioned glass, the shape of the chamfered portion can be selected suitably from an R-chamfering, a C-chamfering, a slope, etc., and the volume of the chamfering area, the slope angle and so on can be also adjusted suitably in accordance with the use application, the kind of the bonding agent, etc.

In the laminate according to the present invention, it is preferable that surface roughness of the bond portion of the lamination surface of the glass is lower than surface roughness of the chamfered portion, that is, in a state where the bond portion has a smoother surface than the chamfered portion (or the chamfered portion has a rougher surface than the bond portion). When the bond portion has a smooth surface, the adhesion between the members is improved and the members are hardly separated from each other. On the other hand, when the chamfered portion has a rough surface, it is possible to suppress the bonding agent from flowing toward the outermost part of the end portion. The values of the surface roughness are not limited particularly. For example, the chamfered portion has preferably a surface roughness (Ra) of 0.15 to 0.5 μm, and the bond portion has preferably a surface roughness (Ra) lower than 0.15 μm. The surface roughness (Ra) is an arithmetic average roughness according to JIS B0601 (revised in 2013) of Japanese Industrial Standards.

Next, a method for manufacturing the laminate according to the present invention is described. The laminate according to the present invention is manufactured by bonding two or more members via a bonding agent as described previously.

An end portion of a surface serving as a lamination surface is chamfered to form a chamfered portion. A method for forming the chamfered portion can be selected suitably from means such as polishing, etching, laser machining, grinding, cutting, pressing, etc. It is preferable to select the method in consideration of the physical properties and thickness of the member, a desired slope angle, and a processing width.

A bonding agent is used for bonding members. The kind of the bonding agent can be selected suitably from the aforementioned kinds. In addition, as a method for applying the bonding agent, a method suitable to the state of the bonding agent or the area in which the bonding agent should be applied may be selected. For example, the bonding agent may be printed or may be applied using a coating tool or device if it is a paste-like or frit-like bonding agent, or the bonding agent may be pasted if it is a seal-like or sheet-like bonding agent. In the present description, the mode in which the paste-like or frit-like bonding agent is printed and the mode in which the seal-like or sheet-like bonding agent is pasted are included in the mode in which the bonding agent is applied. In addition, in order to improve the adhesion, processing such as applying force (for example, placing a weight, pinching with a tool, etc.) or heating may be performed.

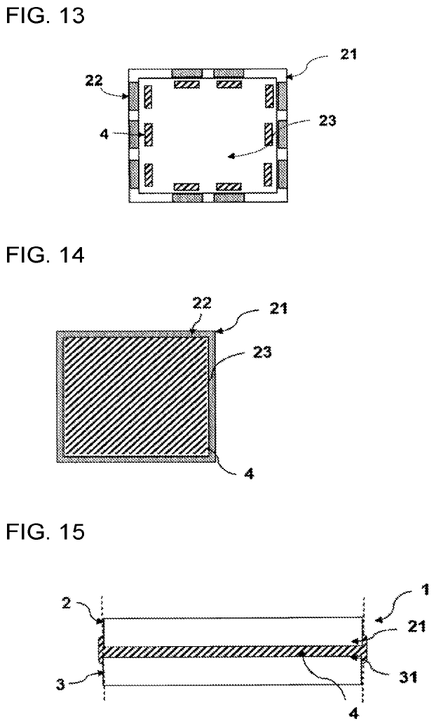

As for the area in which the bonding agent should be applied, it is preferable to apply the bonding agent to the bond portion other than the position where the chamfered portion is formed in the lamination surface. Examples of the applying method are shown in FIG. 11 to FIG. 14. The bonding agent may be applied to only the inside of the part where the chamfered portion is formed, or the bonding agent may be applied to only a part of the inside of the part where the chamfered portion is formed. Alternatively, the bonding agent may be applied all over the lamination surface.

Embodiments 1 to 10 of the present invention is shown below. Changes in the chamfering shape, the angle and the width in each of the following embodiments or forms in which some of the embodiments are combined can be adjusted appropriately within the scope of the present description.

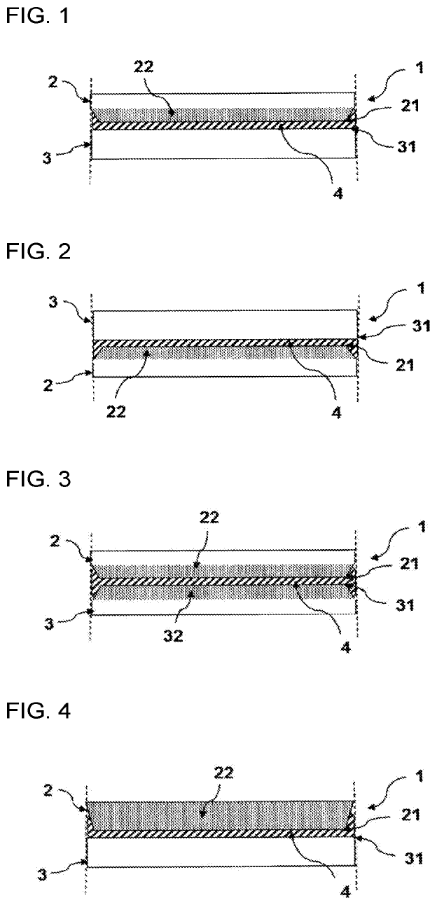

In Embodiments 1 and 2, as shown in FIG. 1 and FIG. 2, the glass 2 has a chamfered portion 22 in an end portion of a lamination surface 21 of the glass 2. The shape of the chamfered portion 21 is set as a C-chamfering.

In Embodiment 3, as shown in FIG. 3, the glass 2 and the member 3 have chamfered portions 22 and 32 in both an end portion of a lamination surface 21 of the glass 2 and an end portion of a lamination surface 31 of the member 3. The shape of each chamfered portion 22, 32 is set as a C-chamfering.

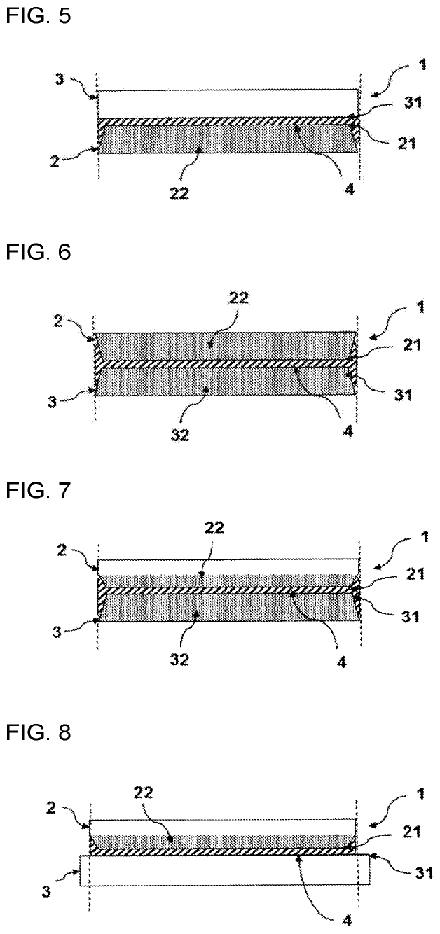

In Embodiments 4 and 5, as shown in FIG. 4 and FIG. 5, the glass 2 has a chamfered portion 22 in an end portion of a lamination surface 21 of the glass 2. The shape of the chamfered portion 21 is set as a slope shape inclined in the thickness direction as a whole.

In Embodiment 6, as shown in FIG. 6, the glass 2 and the member 3 have chamfered portions 22 and 32 in both an end portion of a lamination surface 21 of the glass 2 and an end portion of a lamination surface 31 of the member 3. The shape of each chamfered portion 22, 32 is set as a slope shape inclined in the thickness direction as a whole.

In Embodiment 7, as shown in FIG. 7, the shape of a chamfered portion 22 in an end portion of a lamination surface 21 of the glass 2 is different from the shape of a chamfered portion 32 in an end portion of a lamination surface 31 of the member 3. In the case of Embodiment 7, the shape of the chamfered portion 22 is set as a C-chamfering, and the shape of the chamfered portion 32 is set as a slope shape inclined in the thickness direction as a whole.

In Embodiment 8, as shown in FIG. 8, the size of a lamination surface 21 of the glass 2 is smaller than the size of a lamination surface 31 of the member 3. In the case of Embodiment 8, a chamfered portion is formed only in the glass 2, and the chamfered portion 22 is formed as a C-chamfering.

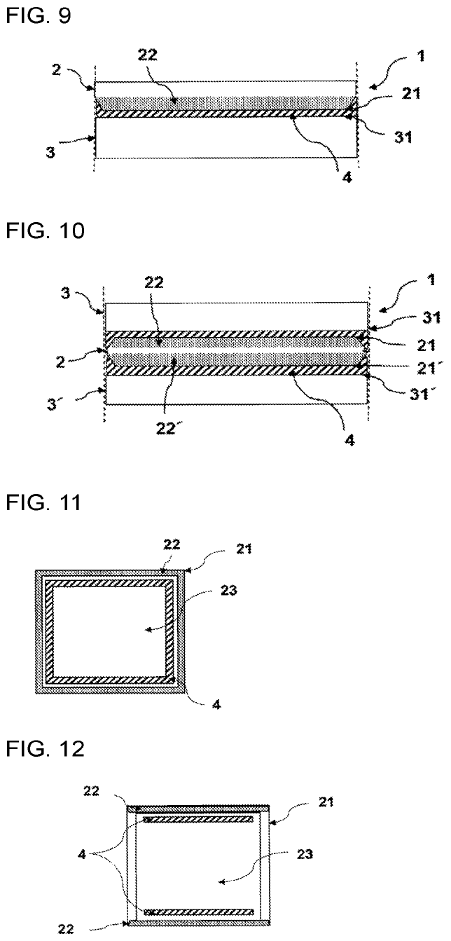

In Embodiment 9, as shown in FIG. 9, the thickness of the glass 2 is different from the thickness of the member 3. Embodiment 9 is similar to Embodiment 1, except that the thicknesses are different.

Embodiment 10 shows an example in which members 3 and 3′ are bonded above and below the glass 2, as shown in FIG. 10. The glass 2 has chamfered portions 22 in both lamination surfaces 21 and 21′ of the glass 2. The chamfered portions 22 and 22′ are formed as C-chamfering.

Although the present invention has been described in detail and with reference to its specific embodiments, it is obvious for those in the art that various changes or modifications can be made without departing from the spirit and scope of the present invention.

The present application is based on a Japanese patent application (Japanese Patent Application No. 2017-084724) filed on Apr. 21, 2017, the contents of which are incorporated herein by reference.

### INDUSTRIAL APPLICABILITY

A laminate according to the present invention is extremely useful for applications such as a solid-state image sensing device, an optical element, a carrier glass, a display-related member, a housing of electronic equipment, a solar cell, a laminated glass for a window, etc.

### REFERENCE SIGNS LIST

1. laminate
2. glass
21. lamination surface of glass
22. chamfered portion of glass
23. bond portion of glass
3. member (including glass)
31. lamination surface of member
32. chamfered portion of member
33. bond portion of member
4. bonding agent

1. A laminate in which a plurality of members including at least a glass are bonded via a bonding agent,
wherein the glass bonded has a chamfered portion in an end portion of a lamination surface of the glass, and the bonding agent adheres to the chamfered portion.

2. The laminate according to claim 1, wherein the bonding agent is at least one kind selected from the group consisting of a UV-curing resin, an acrylic-based bonding agent, a silicone-based bonding agent, an urethane-based bonding agent, a polyamide-based bonding agent, a vinyl acetate-based bonding agent, an ester-based bonding agent, a styrene-based bonding agent, a cyanoacrylate-based bonding agent, a PVA-based bonding agent, a PP-based bonding agent, a PC-based bonding agent, a PET-based bonding agent, a PMMA-based bonding agent, a PES-based bonding agent, a PEN-based bonding agent, a cellulose-based bonding agent, a silane coupling-based bonding agent, and an epoxy-based bonding agent.

3. The laminate according to claim 1, wherein surface roughness of a bond portion of the lamination surface is lower than surface roughness of the chamfered portion.

4. A method for manufacturing a laminate in which a plurality of members including at least a glass are bonded via a bonding agent, the method comprising:
chamfering an end portion of a lamination surface of the glass to form a chamfered portion; applying the bonding agent to a bond portion of at least one lamination surface of a plurality of the members; and bonding a plurality of the members via the bonding agent so that the bonding agent adheres to the chamfered portion.
